(19) United States
(12) Patent Application Publication
(10) Pub. No.: US 2002/0039720 A1
(43) Pub. Date: Apr. 4, 2002

(54) Motorized reusable toothbrush

(76) Inventors: Alvin J. Marx, San Antonio, TX (US); Kenneth A. Tarlow, Corte Madera, CA (US)

Correspondence Address: Michelle L. Evans, Gunn, Lee & Keeling, Suite 1500, 700 N. St. Mary's Street, San Antonio, TX, 78205, US

(21) Appl. No.: 10/003,617

(22) Filed: Nov. 2, 2001

Related U.S. Application Data
(63) Continuation-in-part of application No. 09/854,766, filed on May 14, 2001.
Application No. 09/854,766 is a continuation of application No. 09/430,647, filed on Oct. 29, 1999.

(51) Int. Cl. A61C 17/26

(52) U.S. Cl. 433/216; 15/28

(57) ABSTRACT

A motorized, reusable toothbrush and method of using the same. The toothbrush includes a housing with a handle portion, a neck portion and a head portion. At least one of the portions is constructed of a polymeric material, the housing being a one-piece unit. A brush head is rotatably and detachably mounted to the head portion, the brush head having ultra-soft bristles, and a variable, high speed motor being provided for effecting rotation of the brush head. The neck portion has a bend generally within a range of 110° and 130° relative to the handle portion for orienting the brush head generally at a right angle for engagement of a user's teeth. A fixed drive shaft and gear assembly couples the motor to the brush head for effecting rotation thereof. A replaceable, alkaline-based DC power source is provided for operation of the motor, power control being effected by a variable speed power control device which actuates rotation of the brush head in at least two power settings.

This application is a continuation-in-part of co-pending application Serial No. 09/854,766, filed May 14,2001, entitled “Motorized Disposable Toothbrush”, which is a continuation of application Serial No. 09/430,647, filed Oct. 29,1999, issued May 15, 2001 as U.S. Pat. No. 6,230,717 B1.

### BACKGROUND OF THE INVENTION

The present invention relates generally to oral hygiene and, more particularly, to an improved device for cleaning teeth, gums and the like.

Conventional devices for oral cleansing have ranged from the traditional manual toothbrush to electronic devices. Electric toothbrushes, for instance, such as those with axial and lateral oscillating brushes, have been used to simulate the up and down, back and forth strokes of a manual toothbrush. These devices are typically powered by rechargeable, through somewhat short-lived, battery packs and/or tethered electrical cords. While useful for removing debris from the sides of the teeth, they have been found less effective between teeth, under the gums, and around irregularly shaped teeth. User skill and flossing therefore remain essential for optimum oral hygiene. Moreover, the relative weight, cost, degree of reliability, and safety considerations of conventional electric toothbrushes have made them considerably less successful than the manual toothbrush.

Another alternative to the manual toothbrush are devices that utilize water under pressure jet to scour the user's teeth and gums. Typically, a stream of water under relatively high pressure is emitted from one end of a probe, the probe being connected to a water storage cell or reservoir. Although such devices have been generally effective for cleansing, the water velocity necessary for suitable cleaning has been found damaging to gums and other oral tissues. Lower velocity water containing abrasives, plaque dissolving compounds or the like have also been utilized, but not without an increase in cost and decrease in practicality. Water probes have, in addition, been plagued with all of the drawbacks associated with electric toothbrushes.

Another method that has been found useful for cleaning teeth is the use of ultrasonics. An ultrasonic, wave emitting wand or probe, for instance, is inserted in the user's mouth and rubbed gently against areas of the teeth to be cleaned. The waved emitted cause the debris to break down and dislodge from tooth surfaces so that the debris may be readily rinsed from the user's mouth. While highly effective in comparison to other teeth cleaning methods, the relative expense, practicality and reliance on the skill of the user have hindered expansion of the market for ultrasonics oral hygiene applications. In addition, the long term effects of ultrasonics on tooth enamel and gums are generally unknown and are of concern to some users.

Despite the many technological advances in electronic teeth cleaning devices, the old fashioned, manual toothbrush remains the most popular method of cleaning teeth. This is believed to be due not only to its simplicity, practicality, disposability, and cost, but also its many design innovations which have ranged from new bristle materials and patterns to angled brush heads and contoured brush handles. Its effectiveness, however, still depends, in large part, on the skill and vigilance of the user. Steadily increasing costs have led most users to use the same toothbrush well beyond its intended design life. The resulting worn brush with characteristic bowed bristles is not only unsanitary, but also has significantly reduced debris removal capability, particularly for removal between teeth and below the gums.

A toothbrush is therefore desired that not only provides superior cleaning of teeth and gums with minimal effort of the user, but is also safe, practical, convenient and relatively inexpensive.

### SUMMARY OF THE INVENTION

In accordance with one aspect of the present invention is a motorized, reusable toothbrush which comprises a housing with a handle portion, a neck portion and a head portion, at least one of the portions being constructed of a polymeric material, the housing being a sealed one-piece unit. A brush head is rotatably and detachably mounted to the head portion, the brush head having ultra-soft bristles, and a variable, high speed motor being provided for effecting rotation of the brush head. The neck portion includes a bend generally within a range of 110° and 130° relative to the handle portion for orienting the brush head generally at a right angle to a user's teeth. A fixed drive shaft and gear assembly are provided for coupling the motor to the brush head and effecting rotation thereof. The motor is powered by a replaceable, alkaline-based DC power source. Rotation of the brush head is actuated in at least two power settings using a variable speed power control device.

According to another aspect of the present invention is a motorized, reusable toothbrush which comprises a housing with a handle portion, a neck portion and a head portion, at least one of the portions being constructed of a polymeric material, the housing being a sealed one-piece unit. A concave profiled brush head is rotatably and detachably mounted to the head portion, the brush head having ultra-soft bristles, and a variable, high speed motor being provided for effecting rotation of the brush head. The neck portion has a bend generally within a range of 110° and 130° relative to the handle portion for orienting the brush head generally at a right angle to a user's teeth.

A fixed drive shaft and gear assembly is provided for coupling the motor to the brush head and effecting rotation thereof. The motor is powered by a replaceable, alkaline-based DC power source. Rotation of the brush head is actuated in at least two power setting using a variable speed power control device. The device includes an adjustable gear reducer for effecting first and second brush head speeds, respectively.

In accordance with a further aspect of the present invention is a method of cleaning a user's teeth using a motorized, reusable toothbrush, which comprises the steps of:

(i) inserting a head portion of the toothbrush in the user's mouth, the toothbrush comprising a housing with the head portion, a handle portion and a neck portion, at least one of the portions being constructed of a polymeric material, the housing being a sealed one-piece unit, a brush head rotatably and detachably mounted to the head portion, the brush head having ultra-soft bristles, and the neck portion having a bend generally within a range of 110° and 130° relative to the handle portion for orienting the brush head generally at a right angle to a user's teeth;

(ii) engaging a high speed motor in the handle portion for effecting rotation of the brush head at a selected speed, a fixed drive shaft and gear assembly coupling the motor to the brush head for effecting rotation thereof, and a replaceable, alkaline-based DC power source for operating the motor, engagement being effected using a variable speed power control device for actuating rotation of the brush head in at least two power settings.

(iii) placing the rotating brush head in contact with at least one of the user's teeth for a selected time;

(iv) removing the head portion from the user's mouth; and

(v) disengaging the high speed motor.

In accordance with yet another aspect of the present invention is a method of cleaning a user's teeth using a motorized, reusable toothbrush which includes a housing with a head portion, a handle portion and a neck portion, the method comprising the steps of:

(i) engaging a high speed motor in a handle portion of the toothbrush for effecting rotation of a brush head in the head portion of the toothbrush at a selected speed, at least one of the portions being constructed of a polymeric material, the housing being a sealed one-piece unit, a fixed drive shaft and a gear assembly coupling the motor to the brush head for effecting rotation thereof; and a replaceable, alkaline-based DC power source for operating the motor, engagement being effected using a variable speed power control device for actuating rotation of the brush head in at least two power settings;

(ii) inserting the head portion of the toothbrush in the user's mouth, the brush head being rotatably and detachably mounted to the head portion, the brush head having ultra-soft bristles, and the neck portion having a bend generally within a range of 110° and 130° relative to the handle portion for orienting the brush head generally at a right angle to the user's teeth;

(iii) placing the rotating brush head in contact with at least one of the user's teeth for a selected time;

(iv) disengaging the high speed motor; and

(v) removing the brush head from the user's mouth.

According to still another aspect of the present invention, there is provided, in combination, a motorized, reusable toothbrush stand. The toothbrush comprises a housing with a handle portion, a neck portion and a head portion, at least one of the portions being constructed of a polymeric material, the housing being a sealed one-piece unit. A brush head is rotatably and detachably mounted to the head portion, a variable speed power control device, the brush head having ultra-soft bristles, high speed motor being provided for effecting rotation of the head. The neck portion has a bend generally within a range of 11020 and 130° relative to the handle portion for orienting the brush head generally at a right angle to a user's teeth. A fixed drive shaft and gear assembly is provided for coupling the motor to the brush head and effecting rotation thereof. The motor is powered by a replaceable, alkaline-based DC power source. Rotation of the brush head is actuated in at least two power setting using a variable speed power control device. Finally, a support structure is utilized for suspending the toothbrush in a generally upright position.

In accordance with yet a further aspect of the present invention is a motorized, reusable toothbrush assembly which comprises a brush head rotatably and detachably mounted to the head portion, the brush head having ultra-soft bristles, a variable, high speed motor for effecting rotation of the brush head, a replaceable, alkaline-based DC power source for operation of the motor, and a variable speed power control device for rotation of the brush head, the assembly being a sealed one-piece unit.

In accordance with another aspect of the present invention is a motorized, reusable toothbrush assembly which comprises a brush head rotatably and detachably mounted to the head portion, the brush head having ultra-soft bristles, a variable, high speed motor for effecting rotation of the brush head, a replaceable, alkaline-based DC power source for operation of the motor, and a variable speed power control device for actuating rotation of the brush head, the assembly being a sealed one-piece unit. Accordingly, it is an object of the present invention to provide an improved device for oral hygiene.

Another object of the present invention is to provide an electric toothbrush with a non-rechargeable, replaceable, leak proof battery in a sealed one-piece unit which has a design life considerably longer than that of a traditional manual toothbrush and/or bristles thereof.

A further object of the present invention is to provide a practical, reusable, lightweight electric toothbrush that is safe, durable and reliable.

Yet another object of the present invention is to provide an improved electric toothbrush that readily fits the contour of a user's hand.

Still another object of the present invention is to provide an electric toothbrush that effectively cleans virtually any interior portion of a user's mouth with minimal skill and vigilance of the user.

Yet a further object of the present invention is to provide an improved electric toothbrush which is constructed of low cost materials.

Another object of the present invention is to provide an improved oral hygiene device that utilizes no chemical additives.

A further object of the present invention is to provide an improved electric toothbrush that is easy to store for travel and required no adapter, recharger or the like.

Still another object of the present invention is to provide an improved electric toothbrush which is quiet and efficient in operation.

Yet another object of the present invention is to provide a relatively small and readily maneuverable electric toothbrush with gentle brushing action.

Another object of the present invention is to provide an electric toothbrush assembly that is self-standing when placed on a relatively flat surface during non-use.

Still a further object of the present invention is to provide an electric toothbrush suitable for any age group and effective gentle brushing for irregularly shaped teeth, orthodontic braces, false teeth, bridges, crowns or the like.

Yet a further object of the present invention is to provide an improved device and method of cleaning teeth, gums and the like.

Another object of the present invention is to provide an electric toothbrush that is both practical and economical.

The present invention will now be further described by reference to the following drawings which are not intended to limit the accompanying claims.

### BRIEF DESCRIPTION OF THE DRAWINGS

FIG. 1 is a perspective view of a motorized toothbrush, according to one aspect of the present invention.

FIG. 1A is a cut-away perspective view of the brush head and neck portion shown in FIG. 1.

FIG. 1B is a perspective view of a brush head and neck portion according to another aspect of the present invention.

FIG. 2 is a cut-away plan view of the toothbrush set forth in FIG. 1.

FIG. 3 is a cut-away plan view of a motorized toothbrush in accordance with another aspect of the present invention.

FIG. 4 is a cut-away plan view of a motorized toothbrush, in a first operative position, according to a further aspect of the present invention.

FIG. 5 is a cut-away plan view of the toothbrush set forth in FIG. 4A showing the toothbrush in a second operative position and the range of motion of the adjustable neck portion.

FIG. 6 is a sectional view taken along line 6-6 of FIG. 5 showing a flex joint in accordance with the present invention.

FIG. 7 is a cut-away plan view of the toothbrush set for in FIG. 4 showing the toothbrush in a third operative position.

FIG. 8 is an exploded, partial perspective view of a motorized toothbrush according to another aspect of the present invention.

FIG. 9 is a sectional view of a locking power switch for the toothbrush set forth in FIG. 4, in the locked position.

FIG. 10 is a plan view of the switch set forth in FIG. 9.

FIG. 11 is a plan view of the switch set forth in FIG. 9 in the unlocked position.

FIG. 12 is a perspective view of the toothbrush set forth in FIG. 1 mounted upright in a stand.

FIG. 13 is an electronic schematic showing a general purpose, lower power rectifier according to the present invention.

FIG. 14 is an electronic schematic showing a current sensing motor shut-off arrangement, according to one aspect of the present invention.

FIG. 15 is a cut-away plan view of a motorized toothbrush, according to a further aspect of the present invention.

FIG. 16 is a cut-away plan view of a motorized toothbrush, according to yet another aspect of the present invention.

FIG. 17 is a sectional view taken along line 17-17 of FIG. 16.

FIG. 18 is a side view of a flexible switch cover, in accordance with the present invention.

FIG. 19 is an exploded view of the drive shaft assembly of FIG. 16, in accordance with still another aspect of the present invention.

FIG. 20 is a cut-away view of the toothbrush housing of FIG. 15.

FIG. 21 is a side view of the toothbrush of FIG. 15 in use, according to one aspect of the present invention.

FIGS. 22A-22C show steps of toothbrush use according to various aspects of the present invention.

### DETAILED DESCRIPTION OF THE PREFERRED EMBODIMENTS

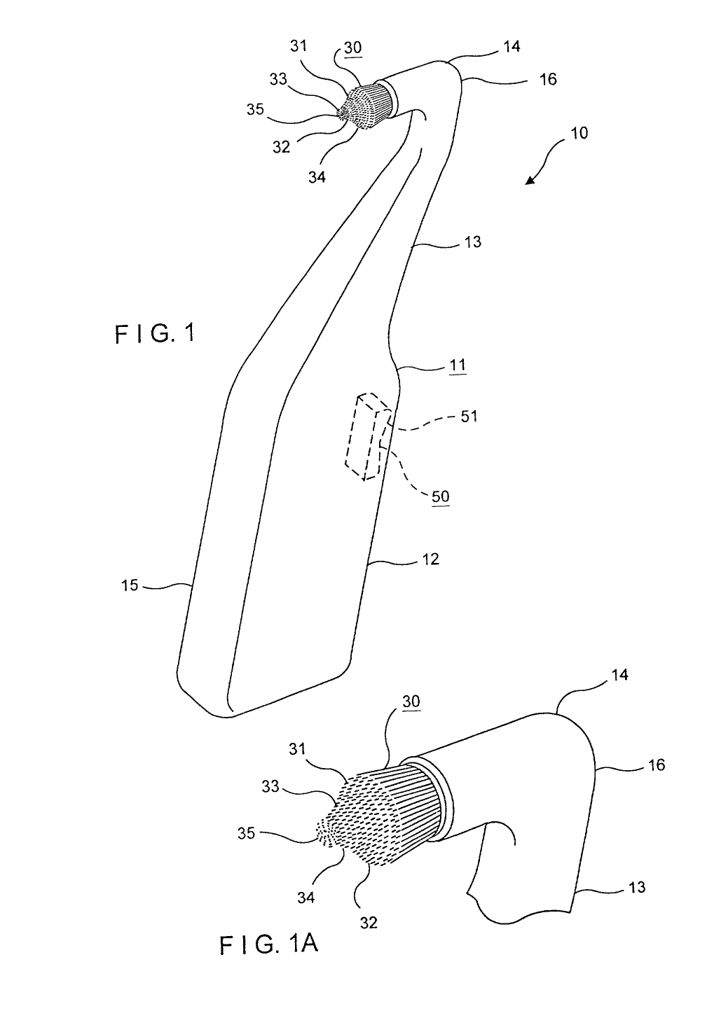

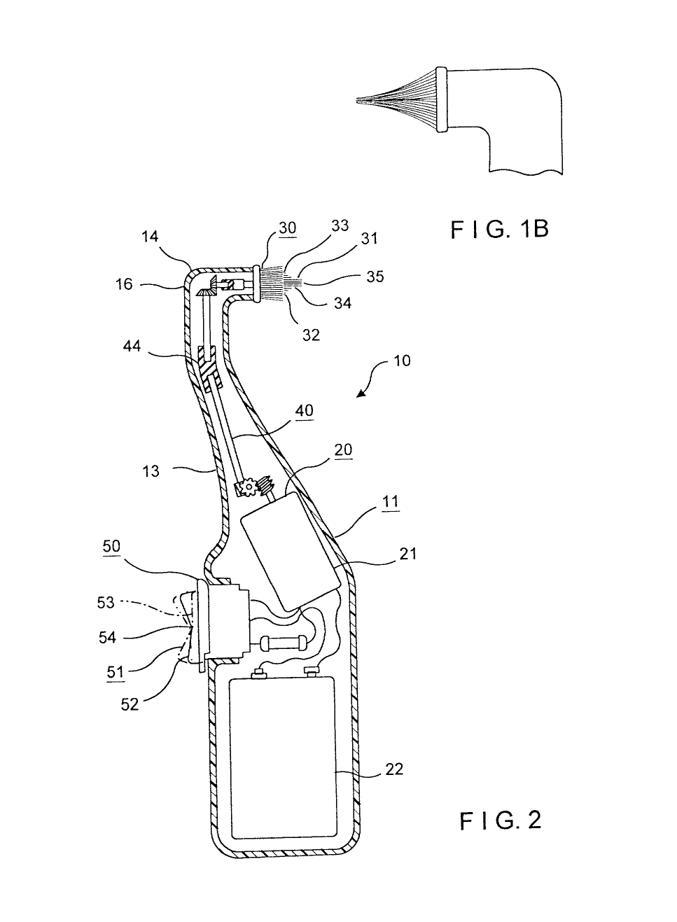

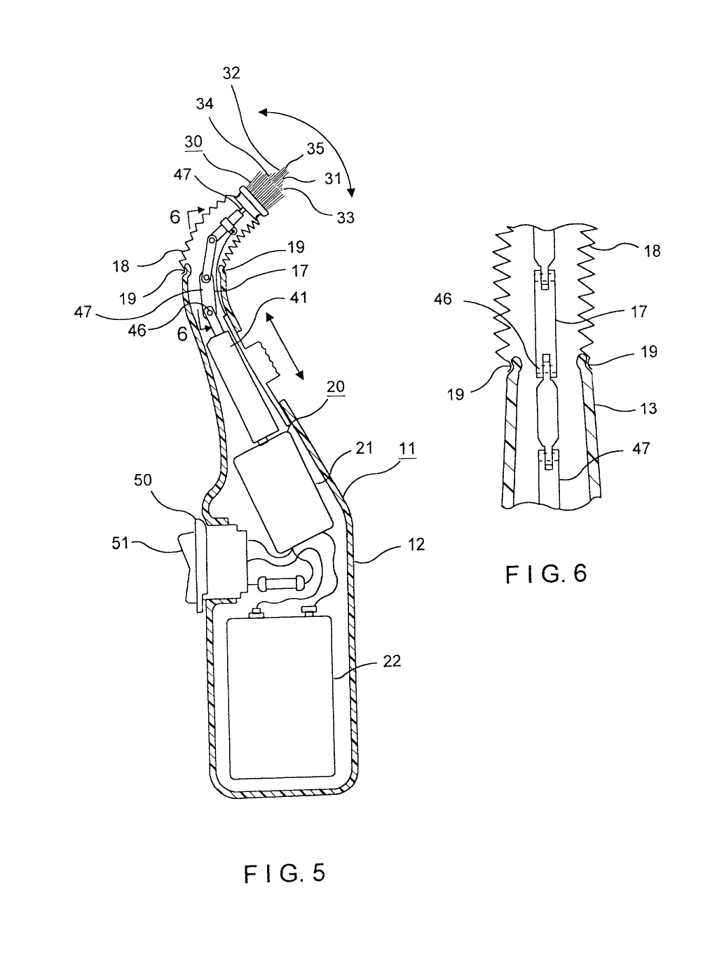

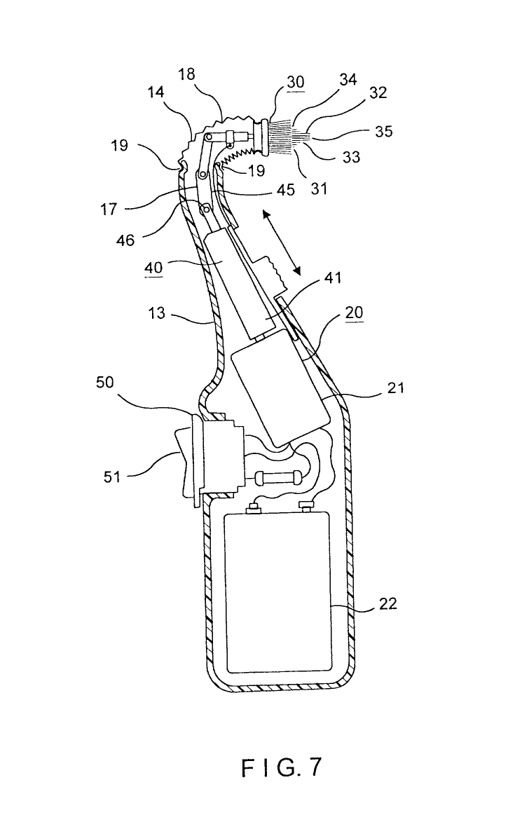

Referring now to the drawings and more particularly to FIGS. 1-22C, there is shown generally a specific, illustrative, motorized, reusable toothbrush 10 according to various aspects of the present invention. As shown in FIG. 1, the toothbrush 10 has a housing 11 with a handle portion 12, a neck portion 13, and a head portion 14. A variable, high speed motor 20 is provided for effecting rotation of a brush head 30 rotatably mounted to the head portion. As shown in FIG. 2, a worm gear and flex joint assembly 40 is provided for coupling the motor to the brush head and for effecting rotation thereof. Rotation of the brush head is actuated in at least two power settings using a variable speed power control device 50.

It is preferred that the housing be a one piece unit 15, effectively sealed from the ingress (or egress) of fluids such as water or air. A one piece construction is advantageous in providing for relatively simple, inexpensive manufacture with an airtight, waterproof seal that prolongs toothbrush life. Specifically, such a seal not only protects the battery and working mechanisms of the toothbrush from moisture, thereby improving reliability, but also enhances safety and prevents battery leakage outwardly from the unit. Each portion of the unit is preferably constructed of a polymeric material such as polyethylene, e.g. HID 112 manufactured by Chevron Corporation. Alternatively or concurrently therewith, a shell construction of a conventional high-impact resistant plastic is also desirable for minimizing risk of damage during travel.

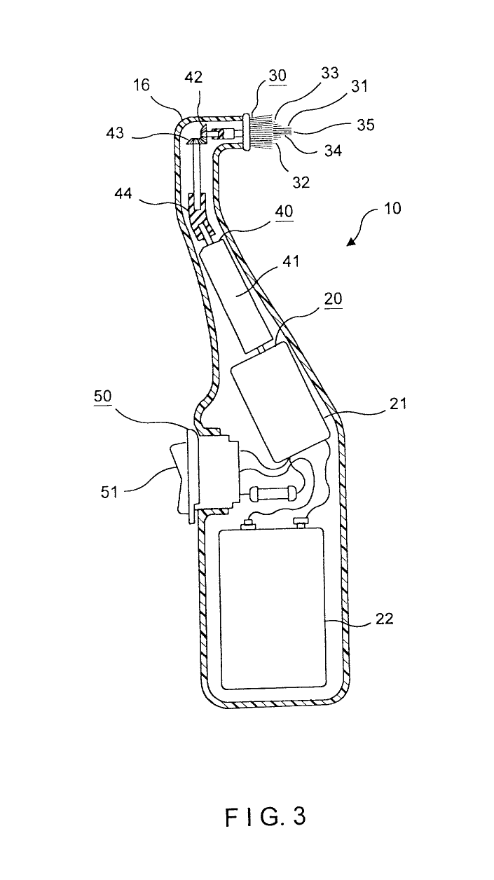

Rotation of brush head 30 is controlled by variable, high speed motor 20 housed suitably in the handle portion for effecting rotation thereof. In accordance with one aspect of the present invention, the brush head is provided with ultrasoft and/or ultrathin, compact nylon bristles 31 formed in a generally cone-like shape, as best seen in FIG. 1A. The sides 32, 33 of the cone have a concave profile 34 and the top 35 is flattened, as illustrated in FIGS. 2 and 3. This configuration has not only been found highly effective ro removing debris from between teeth, but also for cleaning between teeth and gums, rapid cleaning of the crown, as well as use on irregularly shaped teeth.

In an alternative embodiment, as shown in FIG. 1B, the brush head has a flattened shape. This arrangement has been found desirable for debris removal, polishing and gum messaging. In another embodiment, alternatively or concurrently with either of the foregoing brush head configurations, the brush head is detachably secured to the head portion such as by a snap fit for ready removal or replacement.

As indicated in FIGS. 1-3, neck portion 13 is generally fixed at a selected bend 16 for orienting the brush head generally at a hook-like or right angle. This provides ready positioning of the brush head over the user's lip and into generally perpendicular engagement with the user's teeth. The worm gear and flex joint assembly facilitates this effect.

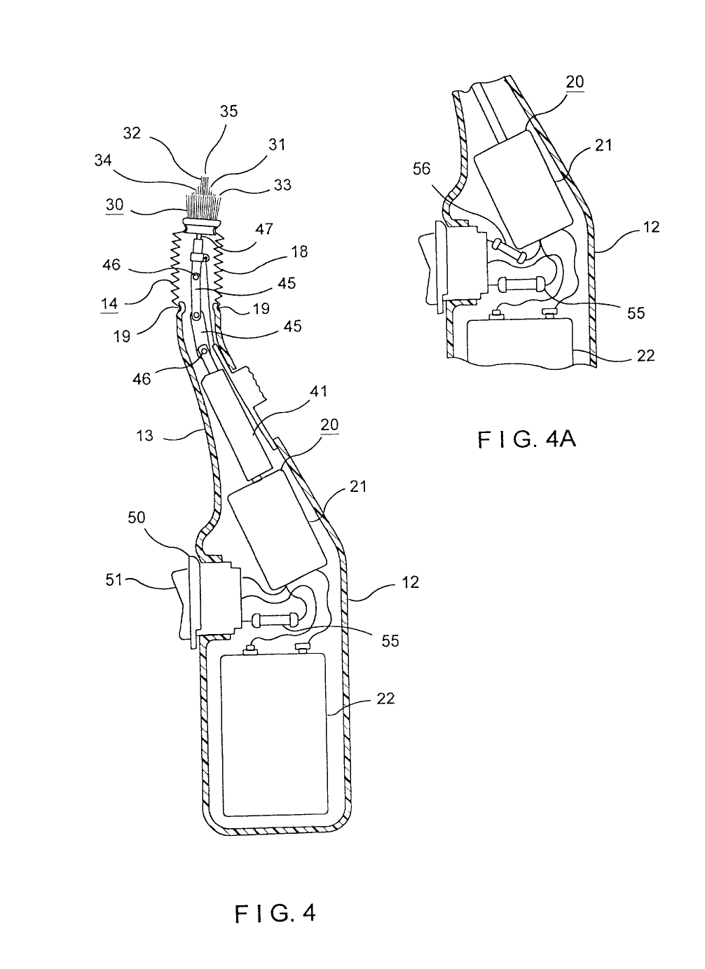

Alternatively, a neck portion is provided that is adjustably flexible, in whole or in part, for variable positioning of the brush head in a selected orientation relative to the handle portion. A toothbrush of this general configuration is illustrated in FIGS. 4-7. Selected adjustment is preferably facilitated by a universal joint and bearing assembly 17 interior to the neck portion and a flex cord 18 comprising the exterior neck portion. The flex cord fits over a coupling lip 19 at the neck mid section for water tight securement therewith.

In this manner, a proper angle of the brush head relative to the teeth, e.g., a right angle, may be maintained for effective brushing. A flexible, bendable neck portion is also advantageous for placing the toothbrush in a stowed or folded position for storage, enhanced portability or the like.

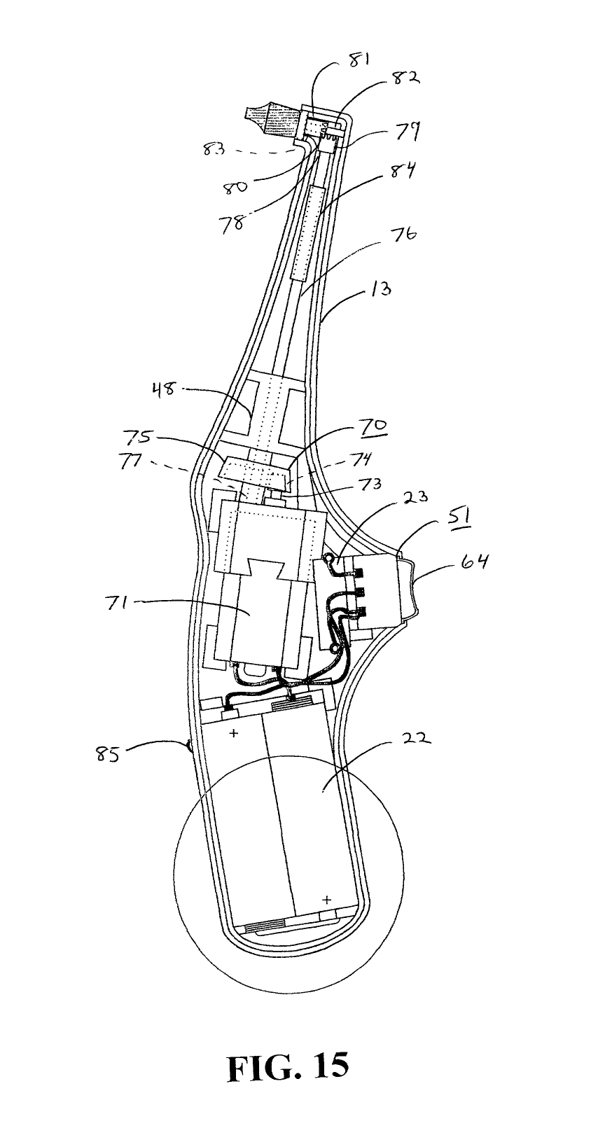

According to a further embodiment, illustrated generally in FIGS. 15-18, neck portion 13 is generally fixed at a bend 16 generally within a range of 11020 and 130° between the axis of the handle portion and that of the neck portion, for orienting the brush head generally at a hook-like or right angle. This also provides ready positioning of the brush head over the user's lip and into generally perpendicular engagement with the user's teeth. Moreover, upon vertical orientation of the toothbrush housing, this angle of bend helps to prevent the user from striking his/her chest during brushing, while maintaining a generally 90° angle between the brush head and the user's teeth.

Furthermore, the motorized reusable toothbrush can be adopted for use by children and youth between 4 and 14 years old. The handle portion 12, neck portion 13, head portion 14 and brush head 30 can all be made smaller. In the handle portion 12 one DC power source 22 can be used instead of two.

The motorized reusable toothbrush can also be adopted for veterinary use. Cats and dogs develop periodontal disease. They can be trained to tolerate toothbrushing. To adopt the toothbrush for veterinary use, the size of some of the components would be modified. In general, for animal use the neck portion 13 should be lengthened. For larger animals, the head portion 14 and brush head 30 should be larger and for smaller animals the head portion 14, brush head 30 and neck portion 13 should be smaller.

As shown in FIGS. 2-7, motor 20 is preferably a conventional, low current DC motor 21 with a capacity of at least three (3) volts, powered by a selected DC power source 22 or the like. An objective is to provide selected constant, high speed rotation with slow down upon high pressure contact with the teeth or gums. Suitability of other relatively low current motors will be appreciated by those skilled in the art, giving consideration to the purpose for which the present invention is intended.

Power source 22 is preferably alkaline-based, e.g., a pile alkaline battery or the like which is non-rechargeable, replaceable, disposable, leak-proof and has a relatively long life. In this connection, a battery life of up to about six (6) months may be achieved with normal use of the present invention, e.g., two times a day. Battery shelf life is preferably up to about 3 years. According to one aspect of the present invention, a single nine (9) volt alkaline-based battery is provided to operate the motor for extended normal use. Alternatively, the motor is powered by a three (3) volt power source comprising two (2) 1.5 volt alkaline-based batteries. The foregoing arrangements are considered beneficial as power cords, adapters and the like are virtually eliminated.

Although the present invention has been shown and described in connection with a replaceable, alkaline-based DC power source, it will be understood by those skilled in the art that other suitable power sources may be utilized giving consideration to the purpose for which the present invention is intended.

Turning now to internal mechanisms according to the present invention, worm gear and flex joint assembly 40, which couples the motor to the brush head, permits translation of rotational motion from motor 20 to corresponding rotational motion of brush head 30. As will also be understood by those skilled in the art, a gear reducer 41 is preferred for this arrangement not only for facilitating the mechanical conversion, but also for minimizing power requirements vis-a-vis relatively high torque and low gear ratios. The gear reducer is best seen in FIGS. 3-7.

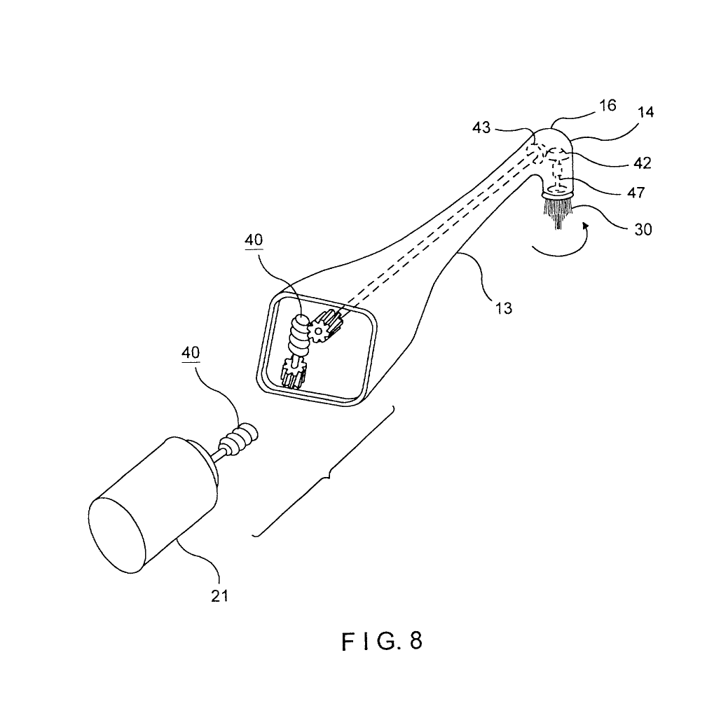

In the fixed neck embodiment, shown generally in FIGS. 2 and 3, the worm gear and flex joint assembly includes a gear reducer 41, a flex joint 44 and gears 42, 43 in the neck portion. The flex joint provides an operative bridge between the axle of gear reducer 41 and gear 43 for highly efficient transfer of axial motion to the brush head. Gears 42 and 43 are preferably mitered for effective, variable angle engagement. Alternatively, as illustrated in FIG. 8, a relatively straight neck portion is utilized whereby the flex joint is omitted.

According to one aspect of the present invention, the gears are suitably constructed of an acetal resin such as Delrin® manufactured by Dupont de Nemours & Company. An objective is to provide a relatively quiet, inexpensive gear drive with enhanced durability and performance.

In the flexible neck embodiment, set forth in FIGS. 3-7, gear reducer 41 is linked to an axle 47 of the rotating brush head by universal joint and bearing assembly 17. The assembly comprises, for instance, a series of segmented coupler members 45 pivotally connected end to end at coupler joints 46. Other conventional worm gear and joint arrangements are considered suitable for this purpose, as will be appreciated by those skilled in the art.

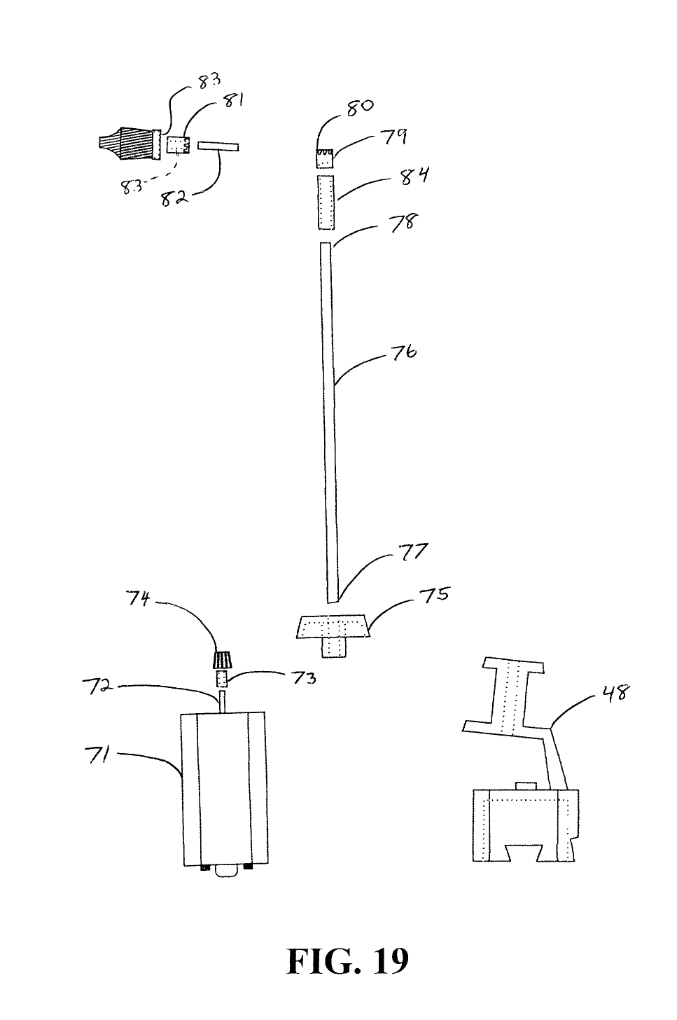

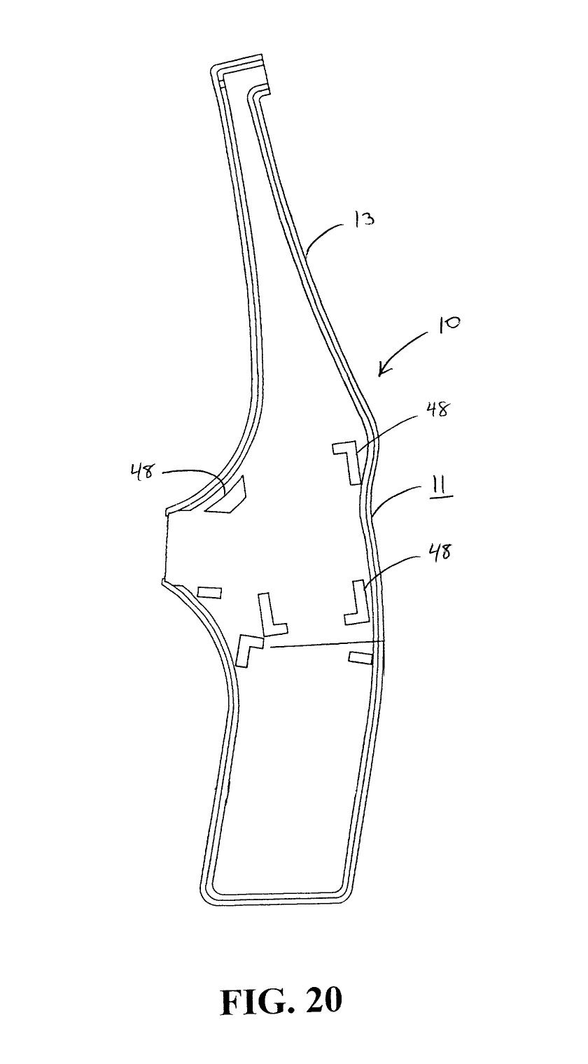

According to another embodiment, as shown in FIGS. 15, 16, and 19, a preferably non-flexible, relatively rigid neck portion 13 is provided for housing a fixed drive shaft and gear assembly 70 for effecting rotation of the brush head. As best seen in FIG. 19, the assembly includes a motor 71 with a spindle 72 and collar 73 extending therefrom. A motor gear 74 is mounted in proximity to the collar for rotatable engagement with a cooperating rotational gear 75 attached to one end 77 of a fixed shaft 76, e.g., a stainless steel rod or the like. As shown in FIGS. 18 and 20, a bracket assembly 48 preferably holds the motor and shaft securely for effective translation of forces from the motor to the brush head, with minimal power consumption.

At an opposite end 78 of the shaft, there is mounted a first turning gear 79 preferably with teeth 80 arranged at a right angle to the rod for manipulating a cooperating second turning gear 81 secured to the brush head. Securement of the second turning gear to the brush head is facilitated by pin 82 which passes through interior portions 83 of the gear and brush head. A weighted sleeve 84 is desirably placed over the shaft to a relatively close fit for selected variation in the moment arm and optimal operation of the turning gears with minimal consumption of energy. This arrangement advantageously provides quiet and efficient toothbrush operation as compared to conventional devices.

Variable speed, power control device 50 for actuating rotation of the brush head is preferably a multi-position pivot switch 51 which may be actuated in at least two power settings. A three-position switch is used, according to one embodiment, the switch having a first position 52 corresponding to a first or LOW power setting, a second 53 corresponding to a second or HIGH power setting, and a third 54 to a power OFF position. Each power setting, in turn, corresponds to a selected brush head speed, for instance, the LOW power setting corresponding to a first brush head speed and the HIGH setting to a second brush head speed. Alternatively, a conventional sliding type multi-position switch may be used.

In one embodiment, gear reducer 41 is utilized for controlling rotation at the first head speed, e.g., about 450 RPM, at a first gear reducer setting having a relatively lower gear ratio. To attain rotation at a second brush head speed such as about 600 RPM, a second gear reducer setting with corresponding higher gear ration has been found desirable. Use of a resistor (not shown), alternatively or concurrently therewith, e.g., about 1 ohm, is also considered within the spirit and scope of the present invention. Low brush head speeds have been found suitable for cleaning near the gum line as having minimal abrasive effect upon the gums, whereas high brush head speeds are considered desirable for cleaning crowns of teeth where maximum abrasion is desired.

In another embodiment, set forth in FIG. 4A, a pair of resistors 55, 56 are provided in place of the gear reducer. Resistor 55, preferably about 1 ohm in magnitude, affects rotation at the first head speed, e.g., about 450 RPM. To attain rotation at the second brush head, e.g., 600 RPM, a resistor 56 of about ½ ohm has been found desirable.

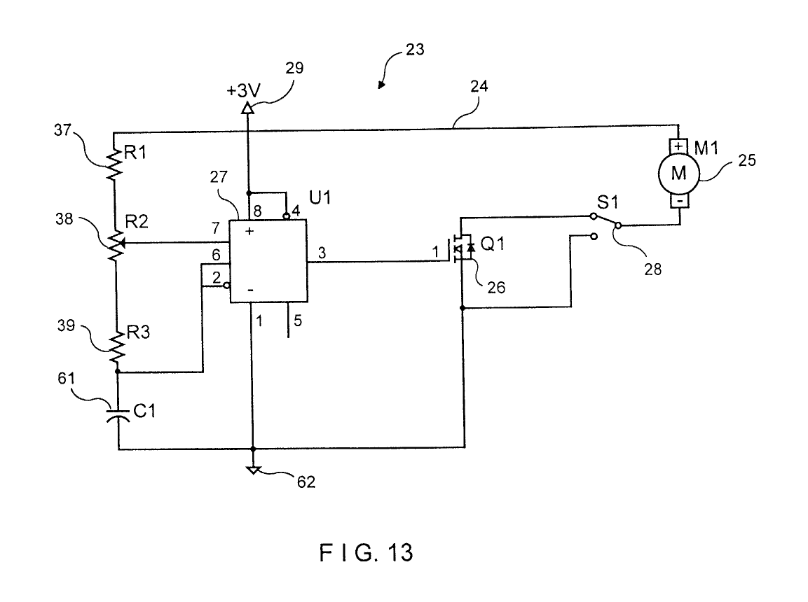

Motor control may, in addition, be accomplished using a two speed, motor controller such as a conventional pulse width modulator 23. An electronic circuit 24 of this general description is illustrated in FIG. 13. The circuit includes a DC motor 25, a MOSFET 26, a microprocessor or chip 27, e.g., part no. LM555CN, a two position switch 28 for selecting fast and slow speeds, a DC power source 29 such as two AA batteries, a series of resistors, 37, 38, and 39, a capacitor 61 and a ground 62. This circuit has been found particularly useful for reliable, precise, low energy speed control at a relatively low cost. A conventional diode, e.g., part no. 1N4001, is also suitable for this purpose as will be understood by those skilled in the art.

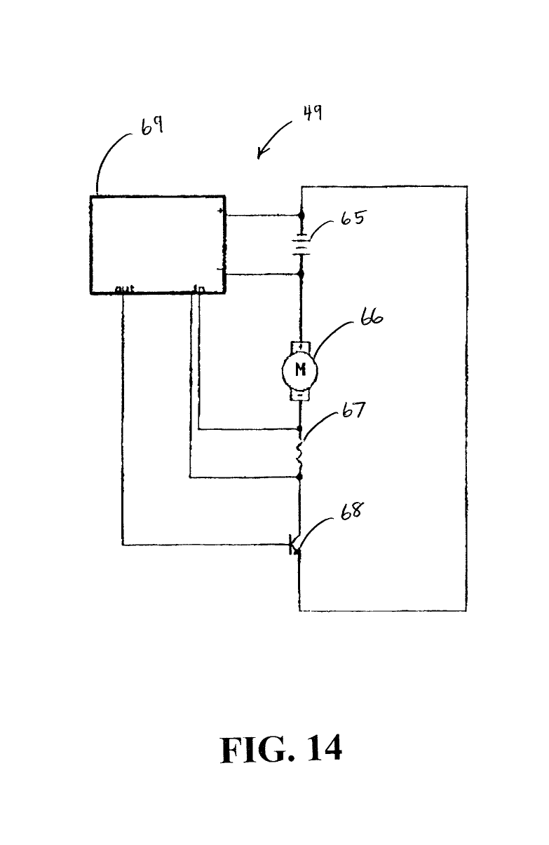

Preferably, the motor operates with a relatively high speed and low torque and has an automatic shut-off circuit 49 which activates in the event the user applies, using the brush, more than a selected amount of pressure on surfaces of the teeth. In one embodiment, as shown in FIG. 14, the circuit includes, in series, a battery 65, a DC motor 66, a current sensing resistor 67 and a transistor 68. The battery, resistor and transistor are arranged in parallel with a current sensing circuit 69 so as to effect automatic shut-off of power to the toothbrush assembly upon exceeding a predetermined current. According to one aspect of the present invention, a relatively moderate to relatively high pressure on the teeth is considered unacceptable as it can lead to excessive gum abrasion and bleeding as well as excess wear and tear on the toothbrush and other components of the brush assembly.

Generally speaking, bristle and brush head geometry as well as speed of rotation are considered relatively important for effective cleaning of teeth and gums, according to the various aspects of the present invention. For instance, in one embodiment, the tip of the brush head is less than about 1 cm in diameter. In particular, with reference to the formula, F(force)=m(mass)×a(acceleration), it has been determined that cleaning pressure is dependent on the force of friction and the area over which it is applied. This relationship, based upon F=ma, is illustrated by the following mathematical expression.

P_{C}=MₖN/A_{c}

Where P_{C} is the cleaning pressure or friction force, Mₖ is the force due to the kinetic friction of the moving brush, N is the normal force exerted by the tooth perpendicular to the tooth surface, and A_{C} is the surface area being cleaned.

Since the dimensions of the tip are relatively small, its cone-shaped head allows more pressure, P_{C}, to be applied more uniformly to the tooth surface without damage to the gums. In addition, a small tip size allows the user to reach under or below the gum line, sparing the gum from lateral pressure. Moreover, the user of a rotating motion with cone-shaped ultrasoft bristles increases the average speed of contact or friction between the bristles and the teeth as compared to conventional oscillating head toothbrushes. While this degree of friction is sufficient for debris removal, it has been found well below the threshold of abrasion to teeth or gums. Stated differently, this unique shape allows more pressure to be applied to the surface of the teeth and less to the gums, particularly when applied to the base of the teeth, i.e., near the gingiva. Hence, the present invention provides an optimum combination of speed, bristle stiffness and geometry for maximum oral cleaning without damage to gums or the like.

Optimal use and comfort of the present invention is further facilitated by the uniquely shaped and sized handle portion 12. This feature not only fits the contour of a wide range of user hands, but also serves to guide the user to an appropriate grip and orientation for optimal use. Moreover, it provides a compact, practical geometry for greater versatility.

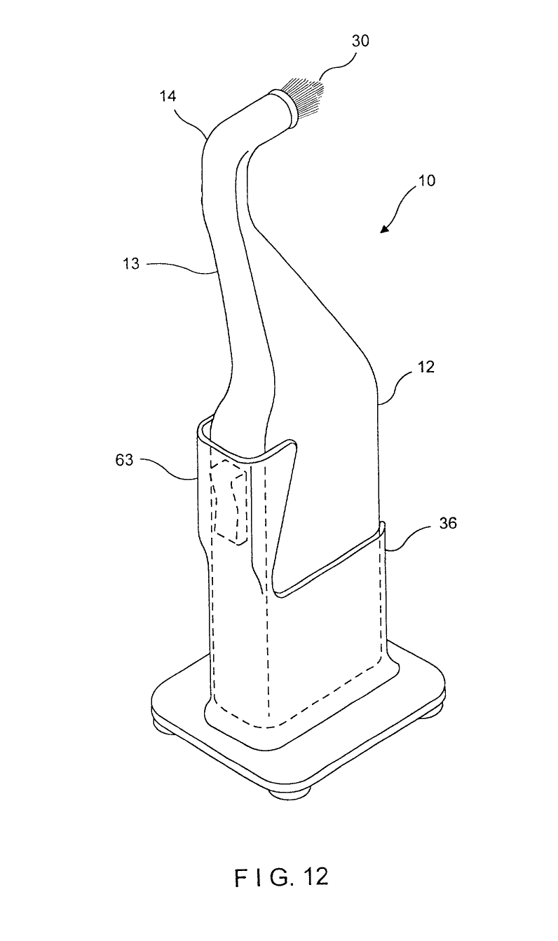

As illustrated in FIG. 12, a stand 36 may be provided for upright storage, protection and ready access to the motorized toothbrush. In this arrangement, according to one aspect of the present invention, bottom surfaces 36a of the toothbrush are rounded for aesthetic appeal, as shown generally in FIG. 15. Upright storage is considered desirable not only for rapid drying of the brush head, but also minimizes accidental damage such as a user knocking or dropping the device onto hard surfaces such as a sink or bathroom floor. In this connection, alternatively or concurrently, the stand is equipped with a switch guard 63 to prevent the device from inadvertent engagement such as during travel in the suitcase and wearing out the battery.

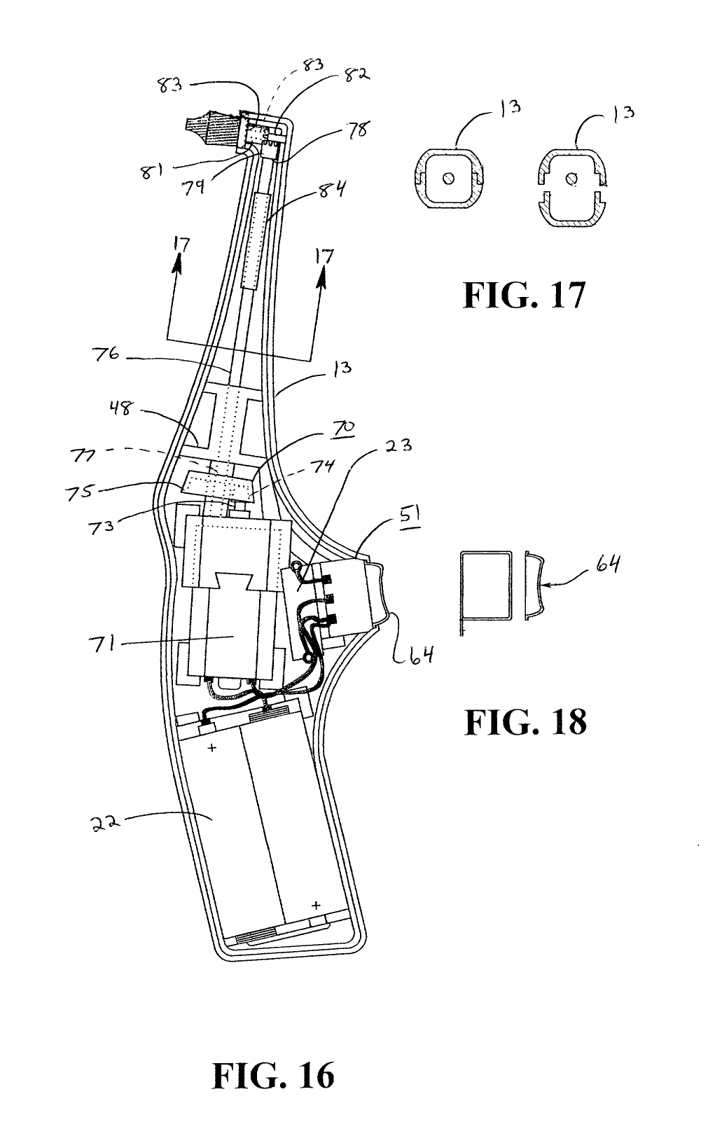

In an alternative embodiment, best seen in FIG. 16, a bottom portion 36b of the toothbrush handle portion is flattened so as to allow the unit to stand freely without the assistance of a stand, as described above, or balancing efforts by the user.

Alternatively or concurrently, the brush head is configured suitable for ready detachment and replacement by a user. According to one aspect of the present invention, a removable brush head is provided, interior portions 83 of the brush head engaging pin 82 in a friction fit for secure, non-permanent engagement therewith. In another embodiment, the pin is provided with a hook-like member 86 (not shown) for snap-like engagement with a cooperating recessed portion 87 (not shown) on the brush head interior. Alternatively, the brush head has a rotatable base (not shown) with waterproof seal for snapping engagement with the neck portion entrance. Accordingly, the brush head may be readily unsnapped from the neck portion, removed and replaced with a new brush head upon signs of worn bristles and/or decreased effectiveness. In this manner, the toothbrush assembly may be converted from a unit that is generally more suitable for disposal to one that is reusable and/or has a more long lasting motorized unit. Desirably, the housing may also be designed to provide a replaceable, but not rechargeable, battery while encased in a one-piece unit in accordance with the present invention.

In another embodiment, shown in FIG. 15, a battery life indicator 85 is provided with, or separately from, the battery for indicating to the user when to dispose of the unit and/or purchase a new one, or when the battery should be replaced. Desirably, a hole, window or the like is provided in the housing, and in proximity to the battery life indicator, for allowing a user to test or observe the battery life remaining.

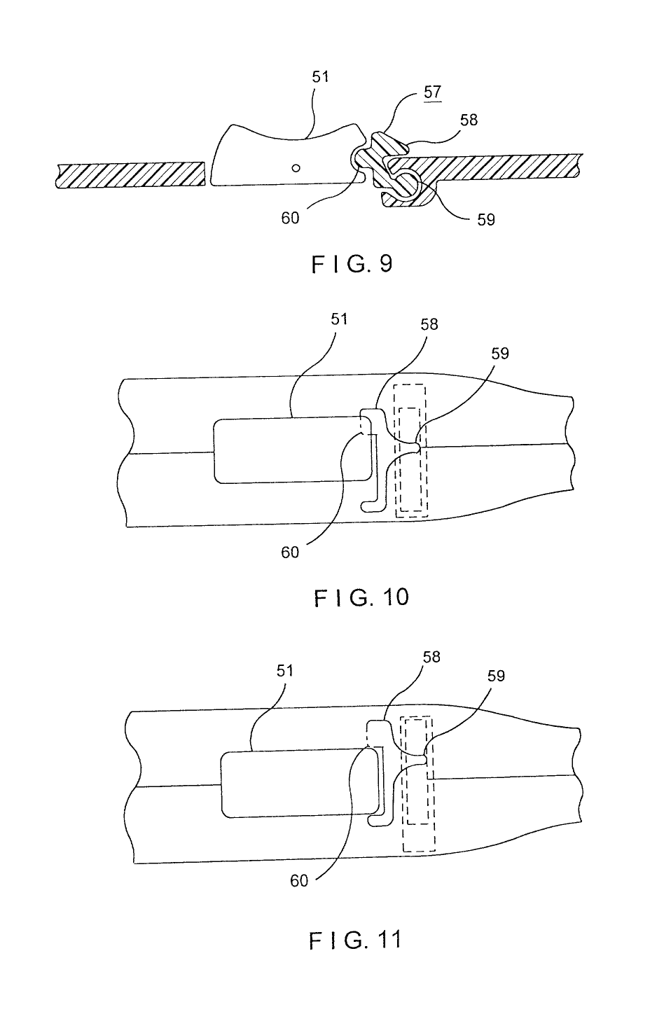

A locking switch 57 is also desirable for use with the motorized toothbrush. A suitable locking mechanism, according to one embodiment, is set forth in FIGS. 9-11. The locking mechanism comprises a sliding latch 58 having dual opposing protrusions 59, 60, one for engaging a groove in the housing and the other mating with a corresponding groove of the power switch. As the switch is moved from a first or unlocked position to a second or lock position, protrusion 60 enters the switch groove, sliding across the same and coming to rest in proximity to a center portion of the switch. To unlock the switch, latch 58 is moved generally in the opposite direction, protrusion 60 sliding back along the groove, until becoming disengaged therefrom. Upon disengagement, the switch is in the unlocked position. Alternatively or concurrently, the switch is placed in a water-tight seal by a flexible cover 64, as shown in FIG. 18.

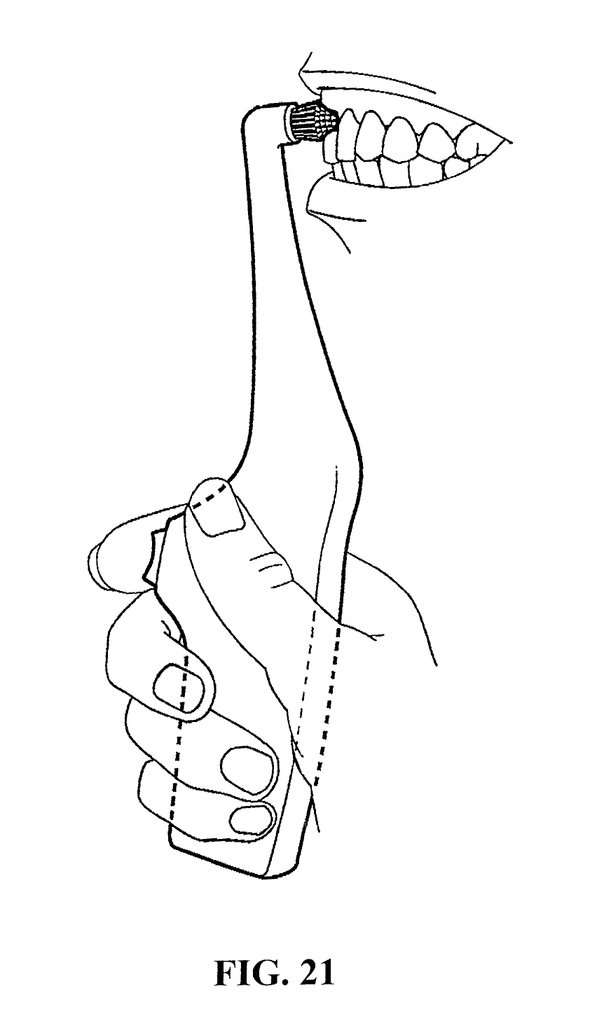

Turning now to operation, a method is provided for cleaning a user's teeth using a motorized toothbrush. Initially, a head portion of the toothbrush is inserted in the user's mouth. Next, a speed setting is selected by the user, the motor in the handle portion being engaged thereby at a relatively high speed. Through a fixed shaft and gear or a worm gear and flex joint assembly, rotation of the brush head is effected. The rotating brush head is then placed in contact with at least one of the user's teeth, as shown in FIG. 21, for a selected time. When a desired degree of cleaning has been achieved, the head portion is removed from the user's mouth, and a high speed motor is disengaged.

Alternatively, a speed setting is first selected by the user, the motor in the handle portion being engaged thereby at a relatively high speed. The head portion is then inserted in the user's mouth. Next, the rotating brush head is placed in contact with at least one of the user's teeth for a selected time. After a desired degree of cleaning has been achieved, the motor is disengaged. The head portion is then removed from the user's mouth.

In another alternative embodiment, a head portion of the toothbrush is initially inserted in the user's mouth. Next, the brush head is placed in contact with at least one of the user's teeth, and a speed setting is selected by the user, the motor in the handle portion being engaged thereby at a relatively high speed. After the rotating brush head has been in contact with at least one of the user's teeth for a selected time and a desired degree of cleaning has been achieved, the high speed motor is disengaged and the head portion is removed from the user's mouth. In still another alternative embodiment, the head portion is removed from the user's mouth and then the motor is disengaged.

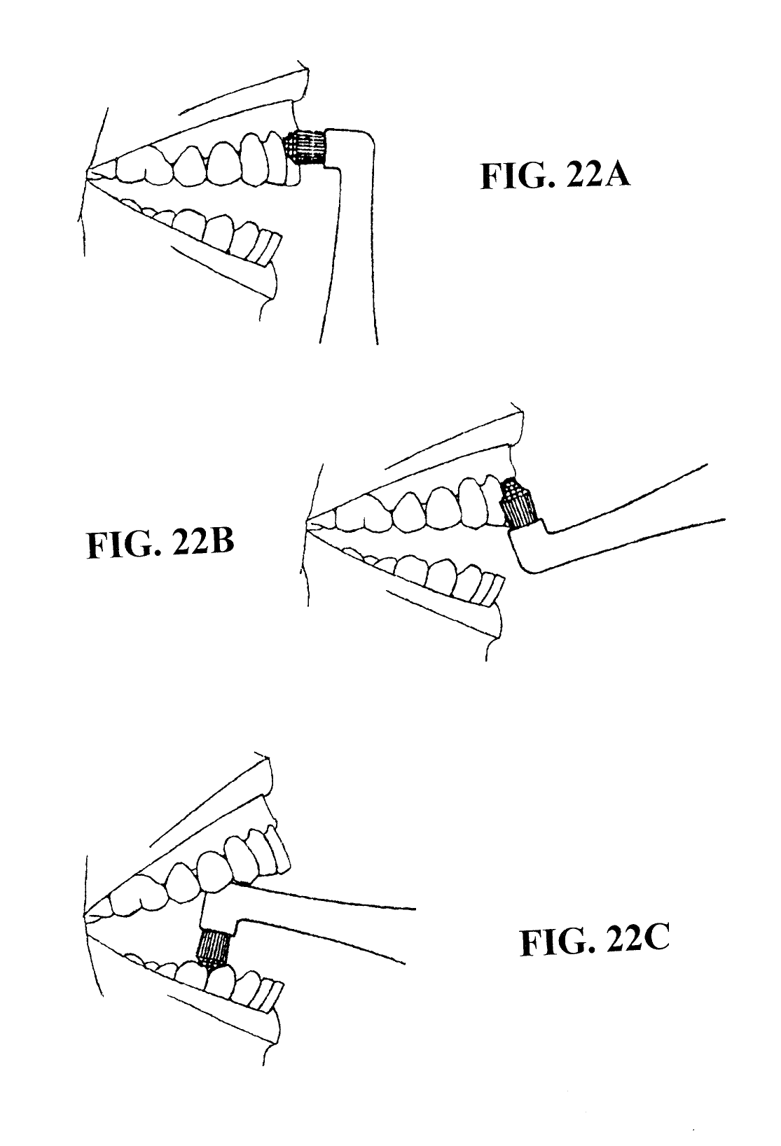

Illustrated in FIGS. 22A-22C are steps of toothbrush use according to various aspects of the present invention. In one embodiment, the head portion of the toothbrush is inserted in the user's mouth, and the brush head placed in contact with and between the user's teeth, and generally perpendicular thereto, as seen in FIG. 22A. A speed setting is selected by the user, the motor in the handle portion being engaged thereby at a relatively high speed. After the rotating brush head has been in contact with at least one of the user's teeth for a selected time and a desired degree of cleaning has been achieved, the toothbrush is turned upwardly, as shown in FIG. 22B, such that the brush head engages spaces between the gums and teeth, generally laterally thereto. Finally, after desired cleansing is achieved, the brush head is moved internally to the user's mouth and the rotating brush head engaged downwardly against top surfaces of the user's molars so as to clean between the user's teeth, and uneven portions thereof. Once a selected degree of cleaning has been achieved, the high speed motor is disengaged and the head portion is removed from the user's mouth. Alternatively, the head portion is removed from the user's mouth and then the motor is disengaged. In still another alternative embodiment, the foregoing teeth cleaning steps are performed in reverse, as will be appreciated by those skilled in the art.

Although the present invention has been shown and described for reuse and battery replacement, its ready disposability is also understood giving consideration to the materials of construction, practicality and the purpose for which the present invention is intended. Illustrative disposable embodiments are shown, for example, in U.S. Pat. No. 6,230,717 B1 entitled “MOTORIZED DISPOSABLE TOOTHBRUSH”, issued to Alvin J. Marx and Kenneth A. Tarlow on May 15, 2001, the disclosure of which is hereby incorporated by reference in its entirety.

Overall, the present invention facilitates superior cleaning between teeth, under gums, and around braces without damage to the gums. The unit's relatively low cost makes it economically feasible as a relatively small, low cost, consumer item, or as a low cost, reusable toothbrush with adaptation of a disposable brush head. Advantageously, wear of the brush head is correlated with battery life to minimize waste. Its durability, effectiveness and practicality are also considered unparalleled.

Various modifications and alterations to the present invention may be appreciated based on a review of this disclosure. These changes and additions are intended to be within the scope and spirit of this invention as defined by the following claims.

What is claimed is:

1. A motorized, reusable toothbrush which comprises:
a housing with a handle portion, a neck portion and a head portion, at least one of the portions being constructed of a polymeric material, the housing being a sealed one-piece unit;
a brush head rotatably and detachably mounted to the head portion, the brush head having ultra-soft bristles, and the neck portion having a bend generally within a range of 11020 and 130° relative to the handle portion for orienting the brush head generally at a right angle to a user's teeth;
a variable, high speed motor for effecting rotation of the brush head, a fixed drive shaft and gear assembly coupling the motor to the brush head for effecting rotation thereof;
a replaceable, alkaline-based DC power source for operation of the motor; and
a variable speed power control device for actuating rotation of the brush head in at least two power settings.

2. The motorized toothbrush set forth in claim 1 wherein the power control device includes a gear reducer for effecting a first brush head speed.

3. The motorized toothbrush set forth in claim 1 wherein the power control device includes a gear reducer for effecting a second brush head speed.

4. The motorized toothbrush set forth in claim 1 wherein the tip of the brush head is less then about 1 cm in diameter.

5. The motorized toothbrush set forth in claim 1 wherein the two power settings correspond to the first brush head speed and a second brush head speed.

6. The motorized toothbrush set forth in claim 1 wherein the power source is at least a 3 volt alkaline battery.

7. The motorized toothbrush set forth in claim 1 wherein the brush head is cone-shaped.

8. The motorized toothbrush set forth in claim 1 wherein the brush head has a concave profile.

9. The motorized toothbrush set forth in claim 1 wherein the neck portion is adjustably flexible for positioning the brush head in a selected orientation relative to the handle portion.

10. The motorized toothbrush set forth in claim 1 wherein the handle portion is shaped and sized so as to fit the contour of a hand.

11. A motorized, reusable toothbrush which comprises:
a housing with a handle portion, a neck portion and a head portion, at least one of the portions being constructed of a polymeric material, the housing being a sealed one-piece unit;
a concave profiled brush head rotatably and detachably mounted to the head portion, the brush head having ultra-soft bristles, and the neck portion having a bend generally within a range of 110° and 130° relative to the handle portion for orienting the brush head generally at a right angle to a user's teeth;
a variable, high speed motor for effecting rotation of the brush head, a fixed drive shaft and gear assembly coupling the motor to the brush head for effecting rotation thereof;
a replaceable, alkaline-based DC power source for operation of the motor; and
a variable speed power control device for actuating rotation of the brush head in at least two power settings, the power control device including a variable gear reducer for effecting first and second brush head speeds.

12. The motorized toothbrush set forth in claim 11 wherein the tip of the brush head is less than about 1 cm in diameter.

13. The motorized toothbrush set forth in claim 11 wherein the power source is about 9 volt alkaline-based battery.

14. The motorized toothbrush set forth in claim 11 wherein the brush head is detachably secured to the head portion.

15. The motorized toothbrush set forth in claim 11 wherein the handle portion is shaped and sized so as to fit the contour of a hand.

16. A method of cleaning a user's teeth using a motorized, reusable toothbrush, which comprises the steps of:
(i) inserting a head portion of the toothbrush in the user's mouth, the toothbrush comprising a housing with the head portion, a handle portion and a neck portion, at least one of the portions being constructed of a polymeric material, the housing being a sealed one-piece unit, a brush head rotatably and detachably mounted to the head portion, the brush head having ultra-soft bristles, and the neck portion having a bend generally within a range of 110° and 130° relative to the handle portion for orienting the brush head generally at a right angle to a user's teeth;
(ii) engaging a high speed motor in the handle portion for effecting rotation of the brush head at a selected speed, a fixed drive shaft and gear assembly coupling the motor to the brush head for effecting rotation thereof, and a replaceable, alkaline-based DC power source for operating the motor, engagement being effected using a variable speed power control device for actuating rotation of the brush head in at least two power settings;
(iii) placing the rotating brush head in contact with at least one of the user's teeth for a selected time;
(iv) removing the head portion from the user's mouth; and
(v) disengaging the high speed motor.

17. A method of cleaning a user's teeth using a motorized, reusable toothbrush which includes a housing with a head portion, a handle portion and a neck portion, the method comprising the steps of:
(i) engaging a high speed motor in a handle portion of the toothbrush for effecting rotation of a brush head in the head portion of the toothbrush at a selected speed, at least one of the portions being constructed of a polymeric material, the housing being a sealed one-piece unit, a fixed drive shaft and gear assembly coupling the motor to the brush head for effecting rotation thereof; and a replaceable, alkaline-based DC power source for operating the motor, engagement being effected using a variable speed power control device for actuating rotation of the brush head in at least two power settings;
(ii) inserting the head portion of the toothbrush in the user's mouth, the brush head rotatably and detachably mounted to the head portion, the brush head having ultra-soft bristles, and the neck portion having a bend generally within a range of 110° and 130° relative to the handle portion for orienting the brush head generally at a right angle to the user's teeth;
(iii) placing the rotating brush head in contact with at least one of the user's teeth for a selected time;
(iv) disengaging the high speed motor; and
(v) removing the brush head from the user's mouth.

18. A motorized, reusable toothbrush assembly which comprises a brush head rotatably and detachably mounted to the head portion, the brush head having ultra-soft bristles, a variable, high speed motor for effecting rotation of the brush head, a replaceable, alkaline-based DC power source for operation of the motor, and a variable speed power control device for actuating rotation of the brush head, the assembly being a sealed one-piece unit.

19. A motorized, reusable toothbrush assembly which comprises a brush head rotatably and detachably mounted to the head portion, a variable, high speed motor for effecting rotation of the brush head, a replaceable, alkaline-based DC power source for operation of the motor with battery life indicator, a variable speed power control device for actuating rotation of the brush head, the assembly being a sealed one-piece unit.
